(19) United States
(12) Patent Application Publication
(10) Pub. No.: US 2007/0196112 A1
(43) Pub. Date: Aug. 23, 2007

(54) Power save mode for an optical receiver

(76) Inventor: Darren S. Crews, Santa Clara, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/360,158

(22) Filed: Feb. 23, 2006

(51) Int. Cl. H04B 10/06

(52) U.S. Cl. 398/202

(57) ABSTRACT

According to embodiments of the present invention, an optical receiver detects an optical signal, determines the signal strength, and is placed in a power save mode if the optical signal strength falls below a predetermined level. A microcontroller may instruct a transimpedance amplifier integrated circuit (TIA IC) or other circuitry in the receiver to turn off one or more of its components during power save mode. If the optical signal strength rises above the predetermined level, the microcontroller may instruct the TIA IC to return to normal mode.

### BACKGROUND

1. Field

Embodiments of the present invention relate to integrated circuits and, in particular, to testing of integrated circuits.

2. Discussion of Related Art

In general, optical receivers may be used to receive data and/or other information on optical signals. Traditional optical receivers have limitations, however.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a simplified block diagram of a mobile platform according to an embodiment of the present invention;

FIG. 2 is a schematic diagram illustrating the power save module depicted in FIG. 1 according to an embodiment of the present invention;

FIG. 3 is a flowchart illustrating a method for operating the mobile platform depicted in FIG. 1 according to an embodiment of the present invention;

FIG. 4 is a simplified block diagram of the mobile platform depicted in FIG. 1 according to an alternative embodiment of the present invention; and

FIG. 5 is a schematic diagram of the optical receiver depicted in FIG. 1 according to an embodiment of the present invention.

### DETAILED DESCRIPTION OF EMBODIMENTS

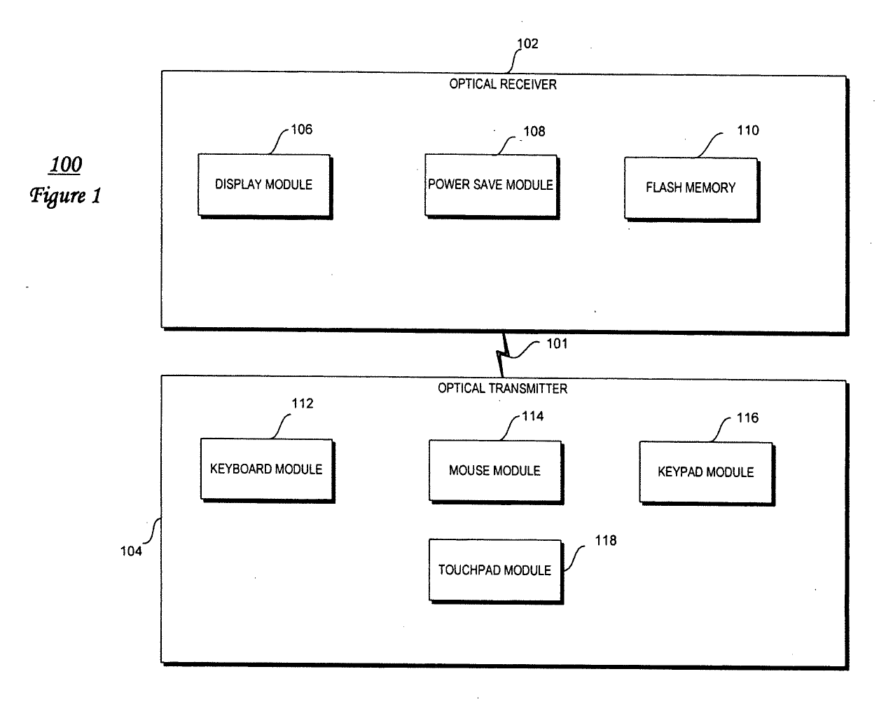

FIG. 1 is a simplified block diagram of a mobile platform 100 according to an embodiment of the present invention in which the receiver implements a power save mode. In the illustrated embodiment, the mobile platform 100 includes an optical receiver 102 optically coupled to an optical transmitter 104 via an optical signal 101. The optical receiver 102 includes a display module 106, a power save module 108, and flash memory 110. The optical transmitter includes a keyboard module 112, a mouse module 114, a keypad module 116, and a touchpad module 118.

In some embodiments the mobile platform 100 may be a foldable cellular telephone. In these embodiments, the optical receiver 102 may be in the upper portion of the telephone where the display 106 is and the optical transmitter 104 may be in the lower portion or body of the telephone where the keypad module 116 is located.

In other embodiments the mobile platform 100 may be a laptop computer. In these embodiments, the optical receiver 102 may be in the upper portion of the laptop computer where the display 106 is and the optical transmitter 104 may be in the lower portion where the keyboard module 112, mouse module 114, and/or touchpad module are located.

In other embodiments the mobile platform 100 may be a portable digital versatile disk (DVD) player. In these embodiments, the optical receiver 102 may be in the upper portion of the DVD player where the display 106 is and the optical transmitter 104 may be in the lower portion where the keyboard module 112 is located.

For some embodiments, the optical transmitter 106 converts and electrical signal into the optical signal 101 and transmits the optical signal 101 to the optical receiver 102. The optical signal 101 may have data thereon generated by pressing a keyboard (not shown) in the keyboard module 112, by moving or clicking a mouse (not shown) in the mouse module 114, by pressing keys (not shown) in the keypad module 116, or by moving or touching the touchpad (not shown) in the touchpad module 118. Alternatively, the optical signal 101 may have control signals thereon.

In some embodiments, the receiver 102 receives the optical signal 101 from the transmitter 104, converts the optical signal back to an electrical signal, and removes the data and/or control signals. The data may be displayed on the display (not shown) in the display module 106. The data may be stored in the flash memory 110. The data and/or control signals may cause a cursor to move on the display. The data and/or control signals may cause text, video, animation, graphics, and the like to appear on the display. The data and/or control signals may cause the display to be illuminated or backlit.

For some embodiments, the display module 106 may be any suitable display module capable of displaying video, including graphics, text, animation, and the like.

Flash memory 110 may be any suitable memory that is capable of being written to and erased in one programming operation, such as an Electrically-Erasable Programmable Read-Only Memory (EEPROM) unit, for example.

For some embodiments, the keyboard module 112 may be any suitable hardware, software, firmware, or combination thereof that includes a keyboard and is capable of interfacing the keyboard with the optical receiver 102.

The mouse module 114 may be any suitable hardware, software, firmware, or combination thereof that includes a mouse and is capable of interfacing the mouse with the optical receiver 102.

For some embodiments, the keypad module 116 may be any suitable hardware, software, firmware, or combination thereof that includes a keypad and is capable of interfacing the keypad with the optical receiver 102.

The touchpad module 118 may be any suitable hardware, software, firmware, or combination thereof that includes a touchpad and is capable of interfacing the touchpad with the optical receiver 102.

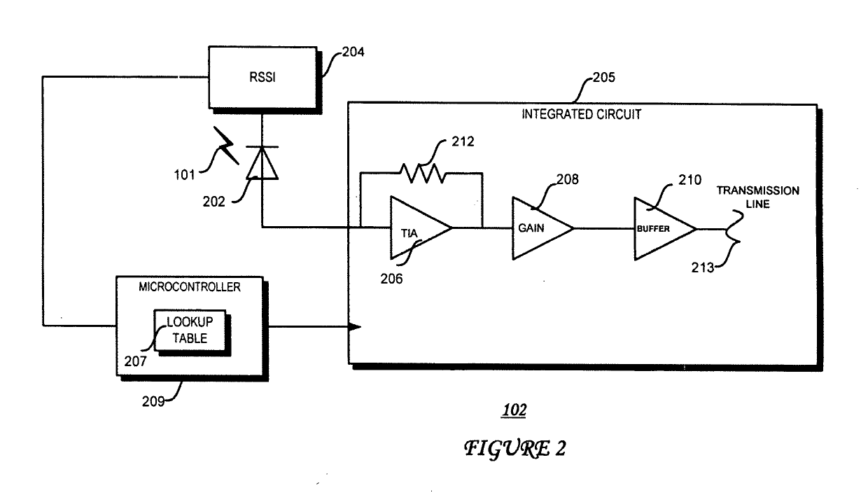

FIG. 2 is a schematic diagram illustrating the receiver 102 and the power save module 108 in more detail according to an embodiment of the present invention. In the illustrated embodiment, the receiver 102 includes a photo detector 202 that is optically coupled to receive the optical signal 101 and electrically coupled to the power save module 108. The power save module 108 includes a received signal strength indicator (RSSI) circuit 204 coupled to a cathode of the light detector 202. The anode of the light detector 202 is coupled to an integrated circuit 205. In the illustrated embodiment, the integrated circuit 205 is shown as a transimpedance amplifier (TIA) integrated circuit 205. However, the integrated circuit 205 may be any integrated circuitry in the receiver 102 and/or on the receiver 102 circuit board. For example, the integrated circuit 205 may be a clock and data recovery (CDR) circuitry, a mixer, a multiplier, a phase-locked loop, a modulator, a demodulator, or other integrated circuitry typically found in a receiver such as the receiver 102. The RSSI circuit 204 also is coupled to a microcontroller 209.

The illustrated transimpedance amplifier (TIA) integrated circuit 205 includes a transimpedance amplifier (TIA) 206 is coupled to a gain stage 208, which is coupled to an output buffer 210. The transimpedance amplifier (TIA) integrated circuit 205 includes a resistor 212 coupled from the input of the transimpedance amplifier (TIA) 206 to the output of the transimpedance amplifier (TIA) 206. The output buffer 210 is coupled to transmission lines 213. The illustrated microcontroller 209 includes a lookup table 207.

For some embodiments, the photo detector 202 may be any suitable photo detector that is capable of detecting the optical signal 101 and converting the optical signal 101 into an electrical signal that is proportional to the optical signal 101. Suitable photo detectors include an avalanche photodiode or a positive-intrinsic-negative (PIN) diode, for example.

The RSSI circuit 204 may be any suitable circuit capable of measuring the strength of the optical signal 101 based on the average current from the light detector 202. The RSSI circuit 204 also may be capable of signaling the transimpedance amplifier (TIA) integrated circuit 205 to go into power save mode when the strength of the optical signal 100 as measured by the RSSI circuit 204 falls below a predetermined level.

The microcontroller 209 may be any suitable circuitry or device capable of comparing the measured value of the optical signal 101 with the predetermined value and instructing the transimpedance amplifier (TIA) integrated circuit 205 to enter a power save mode if the measured strength of the optical signal 101 falls below the predetermined value.

For some embodiments, one or more predetermined values may be stored in the lookup table 207. There may be two different values to provide hysteresis during transition from power save mode to normal mode.

The transimpedance amplifier (TIA) 206 may be any suitable circuitry or device capable of converting the current from the RSSI circuit 204 to a proportional voltage. The output of the transimpedance amplifier (TIA) 206 may be single ended. For some embodiments, a slicer (not shown) may be used to convert the single ended output of the transimpedance amplifier (TIA) 206 to a differential signal, which may be coupled into the gain stage 208.

The gain stage 208 may be any suitable circuitry or device capable of amplifying the signal output from the transimpedance amplifier (TIA) 206. The output of the gain stage 208 may be differential.

The output buffer 210 may be any suitable circuitry capable of driving a differential signal onto the transmission lines 213.

The resistor 212 may provide shunt feedback for the transimpedance amplifier (TIA) 206. The gain of the transimpedance amplifier (TIA) 206 may be proportional to the resistance of the resistor 212.

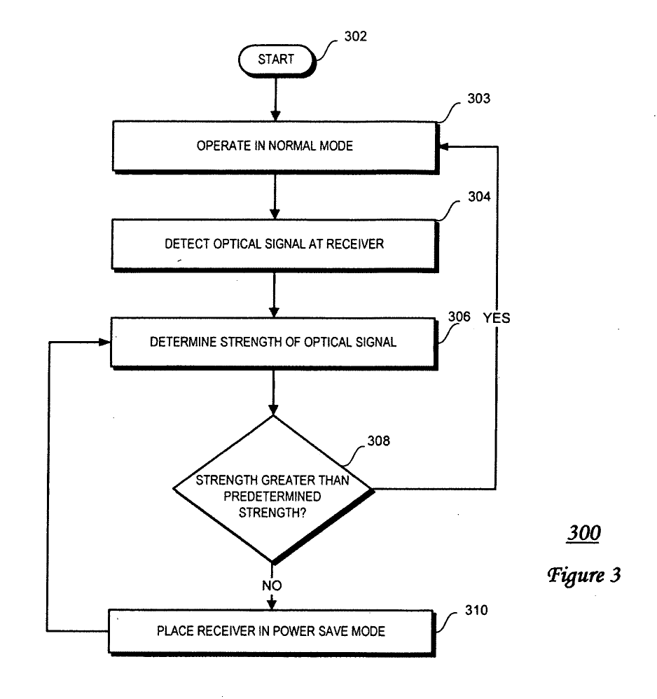

FIG. 3 is a flowchart illustrating a process 300 for operating the mobile platform 100 according to an embodiment of the present invention. The process 300 begins with a block 302, where control passes to a block 303.

In the block 303, the mobile platform 100 operates in a normal mode. In one embodiment, in normal mode, the components in transimpedance amplifier (TIA) integrated circuit 205 are turned on. For example, the transimpedance amplifier (TIA) 206, the gain stage 208, and the output buffer 210 are all turned on.

In a block 304, the mobile platform 100 detects an optical signal at a receiver. In one embodiment, the light detector 202 detects the optical signal 101 sent by the transmitter 104.

In a block 306, the mobile platform 100 determines the strength of the optical signal. In one embodiment, the RSSI circuit 204 measures the strength of the optical signal 101.

In a block 308, the mobile platform 100 determines whether the strength of the optical signal is greater than a predetermined strength. In one embodiment, the microcontroller 209 compares the strength provided by the RSSI circuit 204 with a value stored in the lookup table 207.

If the strength provided by the RSSI circuit 204 is greater than the value stored in the lookup table 207, then the process 300 returns to the block 303 and the receiver 102 continues to operate in normal mode in which the components in transimpedance amplifier (TIA) integrated circuit 205 are turned on. If the strength provided by the RSSI circuit 204 is greater than the value stored in the lookup table 207, then control of the process 300 passes to a block 310.

In the block 310, the mobile platform 100 places the receiver 102 into a power save mode. In one embodiment, the microcontroller 209 may instruct the transimpedance amplifier (TIA) integrated circuit 205 to turn off one or more of the components in transimpedance amplifier (TIA) integrated circuit 205. For example, the microcontroller 209 may instruct the transimpedance amplifier (TIA) integrated circuit 205 to turn off the transimpedance amplifier (TIA) 206, the gain stage 208, and/or the output buffer 210. Alternatively, one or more of the other integrated circuits 205 in the receiver 102 to turn off one or more of its components.

As the example process 300 illustrates, the receiver 102 may remain in power save mode until it is determined in the block 308 that the strength of the optical signal 101 has returned to be greater than the predetermined amount. The process 300 then returns to the block 303 and the receiver 102 returns to operating in normal mode. The components in transimpedance amplifier (TIA) integrated circuit 205 may be turned on.

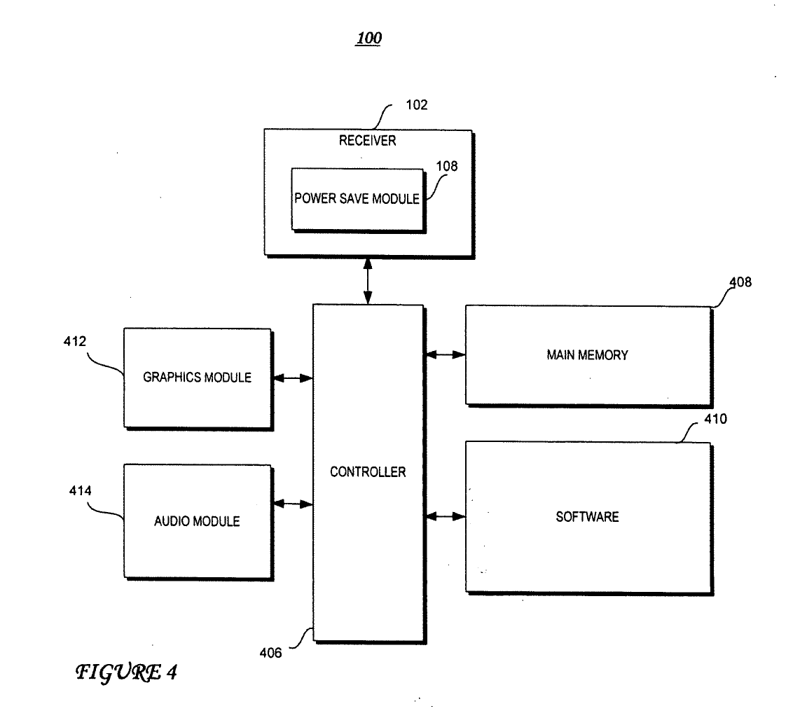

FIG. 4 is a simplified block diagram of the mobile platform 100 according to an alternative embodiment of the present invention. The mobile platform 100 in the illustrated embodiment includes a controller 406 coupled to the receiver 102, main memory 408, software 410, a graphics module 412, and an audio module 414. The receiver 102 includes the power save module 108.

In some embodiments, the controller 406 may manage main memory 408, the graphics module 412, and the audio module 414 and may perform conventional functions of controlling and monitoring the status of memory data lines, error checking, etc. In other embodiments, the controller 406 controls other peripherals.

Main memory 408 in some embodiments performs its conventional functions of storing data (pixels, frames, audio, video, etc.) and software (control logic, instructions, code, computer programs, etc.) for access by other mobile platform 100 components. In general, main memory 408 includes several data lines corresponding to several addressable storage locations. Suitable memory can be a random access memory (RAM).

Software 410, in general, may be control logic, instructions, commands, code, computer programs, etc., executed by the mobile platform 100 to perform functions described herein. Software 410 may implement hyper-threading technology.

The operating system 420 may perform its conventional functions of managing the allocation and de-allocation of resources within the mobile platform 100 during execution of programs. The operating system 420 may be stored in a ROM device.

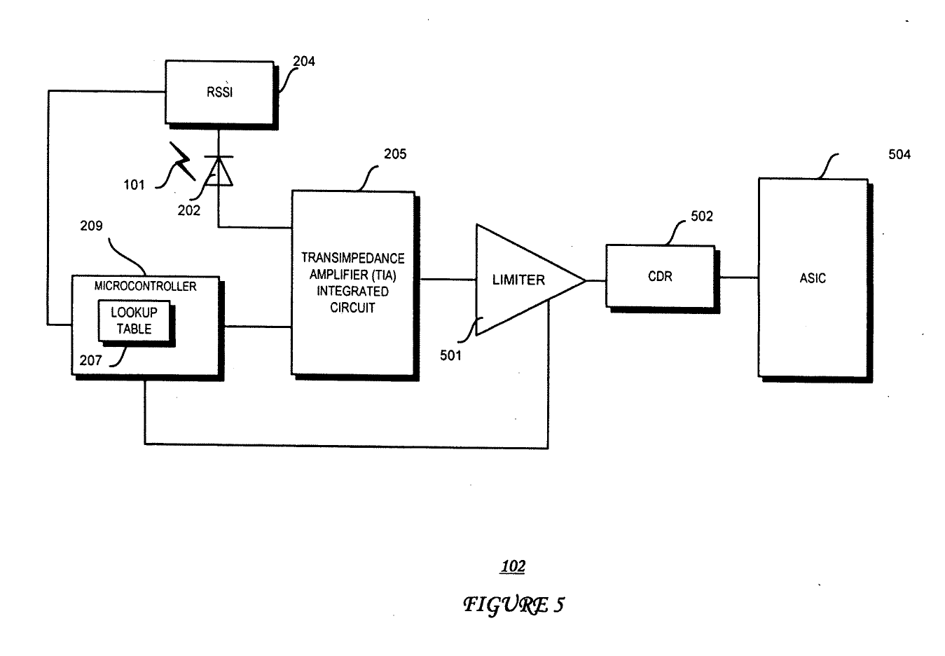

Recall from above that in alternative embodiments one or more of the other integrated circuits 205 in the receiver 102 to turn off one or more of its components during power save mode. FIG. 5 is a schematic diagram of the optical receiver 102 depicted in FIG. 1 according to an embodiment of the present invention in which the microcontroller 209 instructs one or more integrated circuits to turn off in response to the optical signal strength being below a predetermined strength. In the illustrated embodiment, the optical receiver 102 includes a limiting amplifier 501, which is coupled to the integrated circuit 205 and the microcontroller 209, coupled to clock and data recovery (CDR) circuitry 502. The CDR circuitry 502 is coupled to an application specific integrated circuit (ASIC) 504. For some embodiments, the microcontroller 209 may instruct the limiting amplifier 501, the clock and data recovery (CDR) circuitry 502, and the application specific integrated circuit (ASIC) 504 to turn off one or more of its components if the optical signal strength as measured by the RSSI circuit 204 falls below a predetermined strength.

For some embodiments, the predetermined values stored in the lookup table 207 may be different for limiting amplifier 501, the clock and data recovery (CDR) circuitry 502, and/or the application specific integrated circuit.(ASIC) 504. There may be one value for the clock and data recovery (CDR) circuitry 502, a different value for the application specific integrated circuit (ASIC) 504, and still another value for the limiting amplifier 501.

In one embodiment, the input to the limiting amplifier 501 may be a voltage signal (e.g., eye pattern) having a data stream acquired from the optical signal 101. For some embodiments, the limiting amplifier 501 determines which bits in the data stream will be deemed logical ones and which bits in the data stream will be deemed logical zeros. The output of the limiting amplifier 501 may be a serial data stream of ones and zeros.

The clock and data recovery (CDR) circuit 502 may automatically lock on to the serial data stream output from the limiting amplifier 501. In one embodiment, the clock and data recovery (CDR) circuit 502 may be able to automatically lock on to the serial data stream without having to use a reference clock.

The application specific integrated circuit (ASIC) 504 may be any suitable communication interface device. For example, the application specific integrated circuit (ASIC) 504 may be an Ethernet compatible application specific integrated circuit (ASIC), an Infiniband compatible application specific integrated circuit (ASIC), a PCI-Express compatible application specific integrated circuit (ASIC), or other suitable communication device.

The operations of the process 300 have been described as multiple discrete blocks performed in turn in a manner that may be most helpful in understanding embodiments of the invention. However, the order in which they are described should not be construed to imply that these operations are necessarily order dependent or that the operations be performed in the order in which the blocks are presented. Of course, the process 300 is an example method and other methods may be used to implement embodiments of the present invention.

Embodiments of the present invention may be implemented using hardware, software, or a combination thereof. In implementations using software, the software or machine-readable data may be stored on a machine-accessible medium. The machine-readable data may be used to cause a machine, such as, for example, a processor (not shown) to perform the process 300. A machine-readable medium includes any mechanism that may be adapted to store and/or transmit information in a form accessible by a machine (e.g., a computer, network device, personal digital assistant, manufacturing tool, any device with a set of one or more processors, etc.). For example, a machine-readable medium includes recordable and non-recordable media (e.g., read only (ROM), random access (RAM), magnetic disk storage media, optical storage media, flash devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

What is claimed is:

1. An apparatus, comprising:
an optical receiver having:
a photodetector to receive an optical signal and to convert it into a current proportional to the received optical signal;
a circuit to determine a strength of the received optical signal based on the current from the photodetector; and
one or more integrated circuits, all or a portion of the one or more integrated circuits to turn off if the strength of the received optical signal is less than a predetermined strength.

2. The apparatus of claim 1, wherein the integrated circuit includes a transimpedance amplifier to turn off if the strength of the received optical signal is less than a predetermined strength.

3. The apparatus of claim 2, wherein the integrated circuit comprises a gain stage to turn off if the strength of the received optical signal is less than a predetermined strength.

4. The apparatus of claim 3, wherein the integrated circuit comprises an output stage to turn off if the strength of the received optical signal is less than a predetermined strength.

5. The apparatus of claim 1, further comprising a microcontroller to instruct the integrated circuit to turn off if the strength of the received optical signal is less than the predetermined strength.

6. The apparatus of claim 5, wherein the integrated circuit comprises clock and data recovery (CDR) circuitry.

7. The apparatus of claim 6, wherein the integrated circuit comprises phase-locked loop circuitry.

8. The apparatus of claim 1, wherein the integrated circuit to turn on and restore the optical receiver from the power save mode if the strength of the received optical signal goes above a second predetermined strength.

9. The apparatus of claim 8, wherein the second predetermined strength is greater than the first predetermined strength.

10. A method, comprising:
detecting an optical signal at a receiver;
determining a strength of the detected optical signal; and
placing the receiver in a power save mode if the strength of the detected optical signal is less than a predetermined strength.

11. The method of claim 10, further comprising removing the receiver from the power save mode if the strength of the detected optical signal goes above a second predetermined strength different from the first predetermined strength.

12. The method of claim 10, further comprising returning the receiver to a normal mode if the strength of the detected optical signal goes above the predetermined strength.

13. The method of claim 10, further comprising turning off all or a portion of an integrated circuit if the strength of the detected optical signal goes below the predetermined strength.

14. The method of claim 10, further comprising detecting the optical signal at a receiver in a mobile platform.

15. A system, comprising:
an optical receiver having a circuit to determine a strength of a received optical signal and an integrated circuit to turn off and place the optical receiver in a power save mode if the strength of the received optical signal is less than a predetermined strength; and
flash memory to store data carried on the optical signal.

16. The system of claim 15, further comprising circuitry to recover data from the optical signal.

17. The system of claim 15, further comprising a display to graphically depict a representation of the data.
